(19) United States
(12) Patent Application Publication
(10) Pub. No.: US 2004/0109970 A1
(43) Pub. Date: Jun. 10, 2004

(54) Roll dispensable disposable towels

(76) Inventor: Joan Forsyth, Salt Springs, FL (US)

Correspondence Address: Edward M. Livingston, Esq., 628 Ellen Dr., P.O. Box 1599, Winter Park, FL, 32790, US

(21) Appl. No.: 10/316,493

(22) Filed: Dec. 10, 2002

(51) Int. Cl. G09F 3/00

(52) U.S. Cl. 428/43; 428/124; 428/126

(57) ABSTRACT

A folded disposable towel (1, 10) which is folded and attached to like towels with serrated edges (5a, b, 11, 12) can be dispensed from a conventionally sized paper towel roll (2). Once each towel is removed from the roll, it can be opened to form a much larger towel for use as a cleaning towel, beach towel, and so forth. The towel may have one fold one side to open into a two-section towel or folded on both sides into three layers so that when it's opened it forms a towel having three sections.

### BACKGROUND OF THE INVENTION

This invention relates to towels, particularly large disposable paper towels, which are used in lieu of cloth towels, and which are stored in a folded configuration on a conventionally-sized paper towel roll.

Cloth towels, particularly when used for cleaning or at the beach, collect significant sand and debris during use. As a result, such towels must be washed frequently, normally after every use. Such frequent washing not only is time consuming and costly, but results in wear and tear on the towel as well as the washing machines used to wash the towels.

Thus, a need exists for a towel which eliminates the above problem.

Examples of the most closely related known but different devices are described in the following patent documents:

| U.S. Pat. No.: | INVENTOR: | ISSUED DATE: |
|---|---|---|
| 4,0003,509 | Camarero | Jan. 18, 1977 |
| 5,082,707 | Fazio | Jan. 21 1992 |
| 5,322,918 | Kirby | Jun. 21, 1994 |
| 5,902,669 | Steinhardt et al. | Apr. 11, 1999 |
| 3,687,797 | Wideman | Aug. 29, 1972 |
| 3,641,719 | Yang | Feb. 15, 1972 |

The present invention is a towel made of absorbent, flexible, recyclable paper material which is folded in half and serrated at a desired width, and maintained on a roll so it can be dispensed from a roll the size of a conventional paper towel holder.

### SUMMARY OF THE INVENTION

The primary object of the present invention is to provide a towel that does not have to be washed after use.

Another object of the present invention is to provide such a towel that can be easily stored and transported.

A further object of the present invention is to provide such a disposable towel that can be dispensed from a roll the size of a conventional paper towel holder.

The present invention accomplishes the above and other objects by providing a roll-dispensable, disposable towel made of absorbent and flexible material having two sides and two ends, both ends being removably attachable to other towels on a roll of like towels. Each towel is folded on at least one side so after a towel is removed from the roll it can be unfolded to form a large disposable towel. The absorbent and flexible material preferably will be made of recyclable paper. A towel may be further folded along a second side to form a towel forming a larger towel having three sections when fully unfolded.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective view of a disposable towel of the present invention being dispensed from a roll;

FIG. 2 is a perspective view of the disposable towel of the present invention being unfolded after removal from a roll;

FIG. 3 is a top view of the disposable towel of the present invention in the fully opened position for use;

FIG. 4 is a perspective view of the disposable towel with a double fold; and

FIG. 5 is a top view of the fully unfolded disposable towel of FIG. 4;

### DESCRIPTION OF THE PREFERRED EMBODIMENTS

For purposes of describing the preferred embodiment, the terminology used in reference to the numbered components in the drawings is as follows:

| | |
|---|---|
| 1. | Single fold disposable towel |
| 2. | Towel roll |
| 3. | Overlapping open side |
| 4. | Folded side |
| 5.a, b | Serrated edge |
| 6.a, b | Overlapping cut edge |
| 7. | Unfolding direction |
| 10. | Double fold disposable |
| | towel |
| 11. | Proximal, serrated edge |
| 12. | Distal serrated edge |
| 13. | Second fold |
| 14. | First fold |
| 15. | Lower layer |
| 16. | Middle layer |
| 17. | Upper layer |
| 18. | Outer side of double fold |
| | towel |
| 19. | Inner side of double fold |
| | towel |

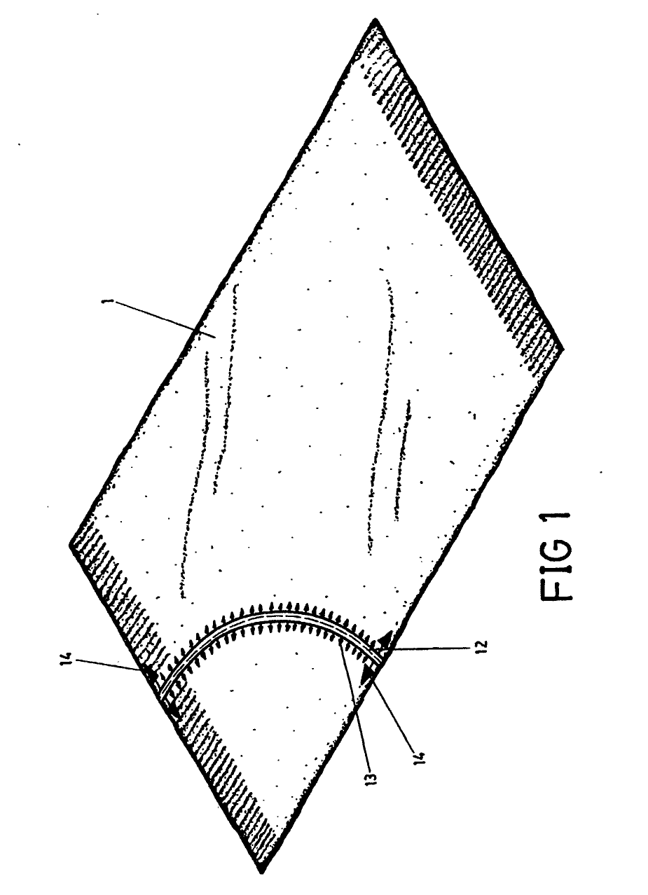

Referring to FIG. 1, a single-fold, disposable towel is illustrated consisting of two layers of towel folded at side 4 and separated at the other side, 3a and 3b. The towel has an outer edge, 6a and 6b, which have already been cut. The towel is removably attached at the inner edge, 5a and 5b, which is serrated and removably attached to another towel on a roll, 2.

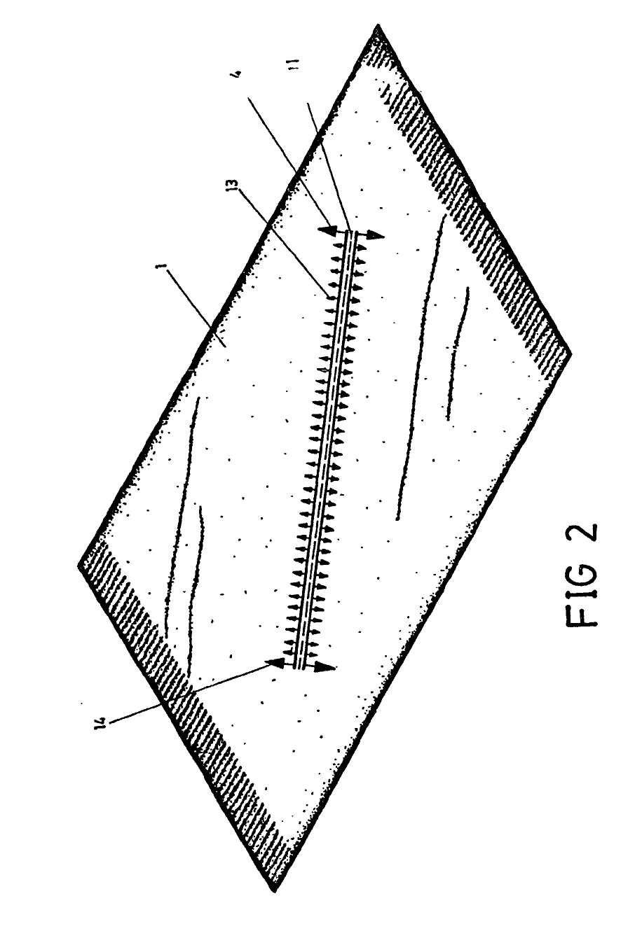

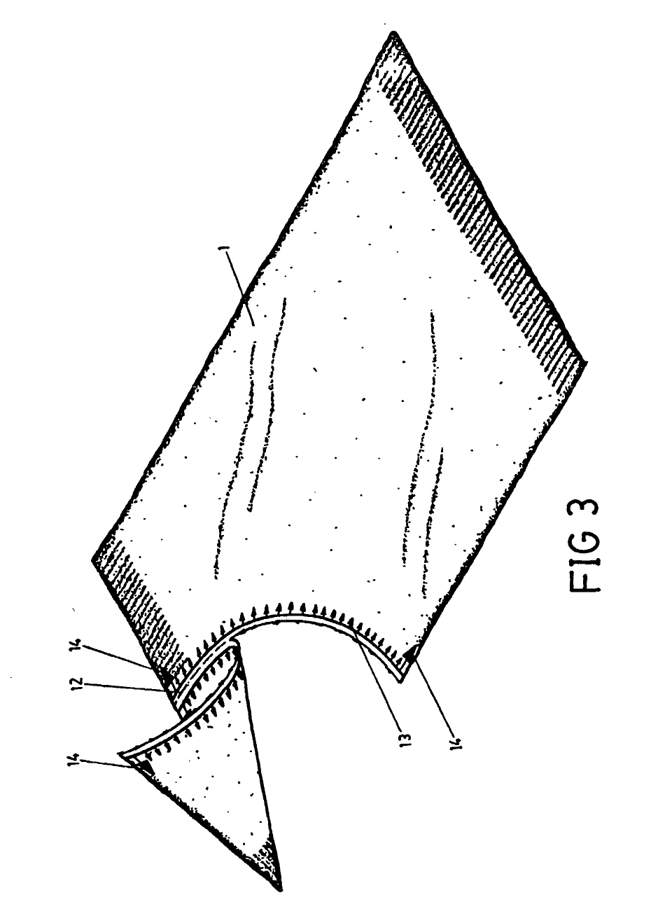

FIG. 2 shows the single-folded towel 1 after it has been detached from the roll 2. Once the towel 1, is detached it is unfolded by moving in direction 7, so that it forms a fully opened towel FIG. 3 having two parallel sides, 3a and 3b, and unfolded edges 6a and 6b, 5a and 5b.

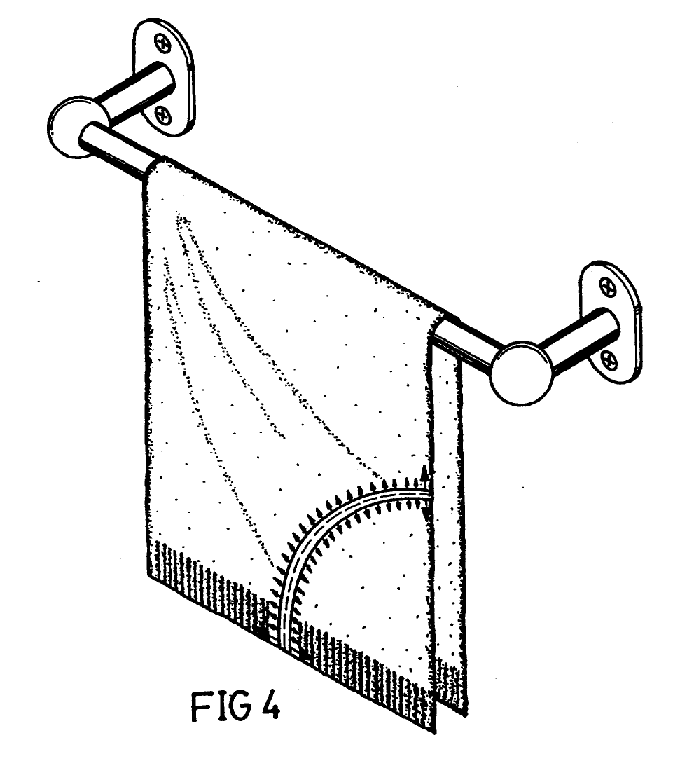

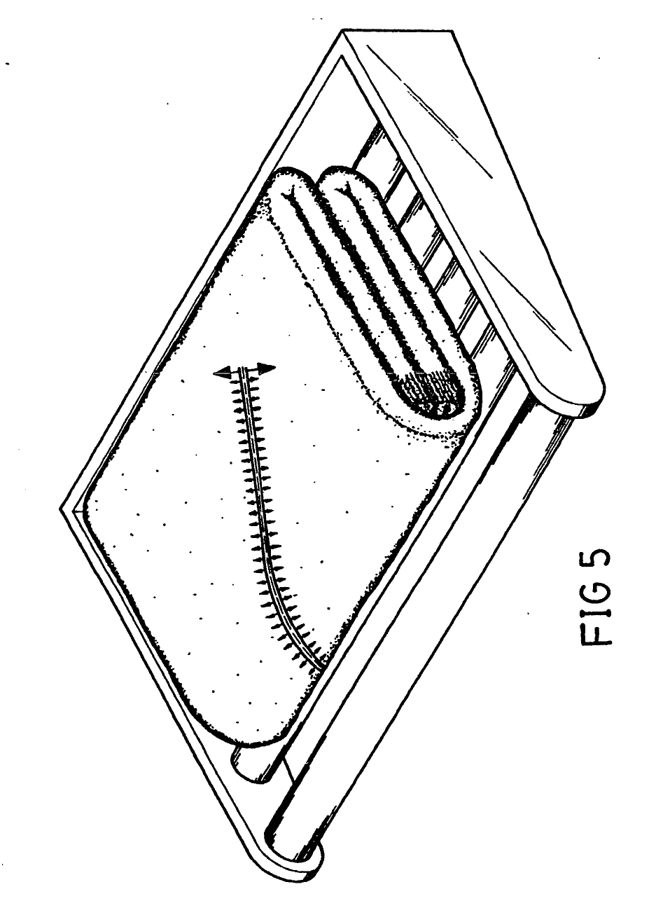

FIG. 4 shows a double-fold disposable towel 10 after having been removed from a roll. Somewhat similar to the single-fold towel 1, the double-fold towel 11 is serrated along its edges 11 and 12 in all of its three layers. The double-folded disposable towel 10 shown in FIG. 4 has three layers and a lower layer at 15, a middle layer at 16, and an upper layer at 16, the first fold at 14 and a second fold at 13 and 24, a first fold at 14 and a second fold at 13. When unfolded, as shown in FIG. 5 forms a double fold towel 10 shown in 5 to provide a large disposable towel having two sides, 18 and 19, two serrated edges, 11 and 12, two folds, 13 and 14, and three sections 15, 16, and 17.

Although only a few embodiments of the present invention have been described in detail hereinabove, all improvements and modifications to this invention within the scope or equivalents of the claims are included as part of this invention.

Having thus described my invention, I claim:

1. (original) A roll dispensable disposable towel comprising:
a towel made of absorbent, flexible material having a first side, a second side and two edges which are removably attachable to edges of adjacent towels on a roll of like towels;
said towel having at least one fold on at least one side so towel can be torn from the roll and unfolded to form a large paper towel.

2. (original) The roll dispensable, disposable towel of claim 1 wherein the absorbent, flexible material is recyclable paper.

3. (original) The roll dispensable, disposable towel of claim 1 wherein the at least one fold on the second side of the towel to form a towel having two sections.

4. (original) The roll dispensable, disposable towel of claim 1 wherein the at least one fold comprises a fold on each side of the towel so once the towel is torn from the roll it opens to form a towel having three sections.
